(19) United States
(12) Patent Application Publication
(10) Pub. No.: US 2008/0097773 A1
(43) Pub. Date: Apr. 24, 2008

(54) NON-DISCLOSURE BOND FOR DETERRING UNAUTHORIZED DISCLOSURE AND OTHER MISUSE OF INTELLECTUAL PROPERTY

(76) Inventors: Michael Hill, Chevy Chase, MD (US); Lang J. McHardy, San Francisco, CA (US); Andrew W. Carter, Glen Ellyn, IL (US); Robert J. Block, Chicago, IL (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/671,899

(22) Filed: Feb. 6, 2007

Related U.S. Application Data
(60) Provisional application No. 60/765,736, filed on Feb. 6, 2006.

(51) Int. Cl. G06Q 99/00

(52) U.S. Cl. 705/1

(57) ABSTRACT

The invention in some embodiments comprises a non-disclosure bond that deters a receiving party from disclosing confidential information and/or compensates a disclosing party in the event the receiving party discloses the confidential information.

### CROSS-REFERENCE TO RELATED APPLICATION

This application claims the benefit of U.S. Provisional Application No. 60/765,736, filed Feb. 6, 2006.

### BACKGROUND OF THE INVENTION

1. Field of the Invention

The present invention in various embodiments relates to a financial bond instrument designed to deter persons from misconduct related to business transactions.

2. Description of the Related Art

Companies rich in intellectual capital frequently disclose or otherwise share valuable trade secrets and other intellectual property with outside parties such as service providers, contractors, consultants, advisors, intermediaries and actual or prospective joint venture partners. Most such disclosures are made for the limited purpose of advancing a specific transaction or project, and the disclosures are typically governed by written confidentiality or non-disclosure agreements (“NDAs”). A party disclosing confidential information (“Disclosing Party”) often faces serious risks from negligent or intentional misconduct by a party receiving the confidential information (“Receiving Party”). NDAs and today's liability insurance policies are typically substantially ineffective in (a) deterring such misconduct or (b) remedying the wrong.

In the case of intellectual property (i.e., trade secrets) in particular, an unauthorized disclosure by the Receiving Party may effectively vitiate the Disclosing Party's property rights. Even in the absence of such an unauthorized disclosure, the absence or paucity of contractual or other safeguards may be used as evidence by parties challenging the validity or enforceability of the intellectual property rights at issue.

Disclosing and Receiving Parties often enter into NDAs under which a Receiving Party promises to provide compensation to the Disclosing Party if the Receiving Party breaches the NDA by disclosing the trade secret to a third party without authorization. Contractual indemnities are an insufficient mechanism for managing the risk of disclosure of confidential information. For example, Receiving Parties of confidential information who breach confidentiality provisions are generally unlikely to respect indemnity provisions of contractual agreements. Receiving Parties may also lack sufficient assets to fully compensate the Disclosing Parties for the losses associated with disclosure of confidential information. Conversely, the cost of enforcing an NDA may be highly inefficient, or even prohibitively high relative to the amount of loss suffered.

Some insurance companies sell liability policies to entities who may be interested in disclosing or receiving confidential information. However, these too are a sub-optimal risk management policy for several reasons. For example, in many liability policies, the insurer has a duty and a right to defend the policyholder, typically making the insurer an ally of the recipient of confidential information and adversary of the Disclosing Party. This conflict gives the recipient the means as well as the incentive to dispute claims. Moreover, liability policies also commonly exclude willful infringement, offering no recovery to the Disclosing Party under those circumstances most likely to occur or most likely to be damaging. Insurers frequently dispute coverage with policyholders, leaving any recovery by the Disclosing Party at risk. In liability policies, relevant protection is often very limited because of either coverage exclusions (in general commercial policies) or capacity or other limitations (for example, in specialty intellectual property policies). Specialty intellectual property coverage is very expensive when available at all because insurers perceive blanket infringement risk to be an unprofitable line of business, as intellectual property is difficult to value and varies in value over time. Capacity for trade secret misappropriation liability is even more limited because most of the limited capacity in the intellectual property insurance marketplace is reserved for patent risk.

Thus Disclosing Parties face myriad risks to core intellectual property value each time they enter into agreements giving other parties access to or control over intellectual property assets, particularly when those assets involve trade secrets or other confidential information. Contractual indemnity arrangements often do not effectively transfer or otherwise manage such risks. There remains a lack of sufficient financial mechanisms for deterring the recipients of confidential information from disclosing or otherwise misusing that information. Similarly, there is a lack of available financial instruments to provide adequate and realizable recovery of losses for a party whose confidential information is misused.

### DESCRIPTION OF EMBODIMENTS OF THE INVENTION

Embodiments of the present invention provide methods for deterring recipients of confidential information from disclosing that information. Some embodiments also provide for recovery by the Disclosing Parties as full or partial compensation for the breach of the confidentiality terms. Some embodiments of the present invention relate to the issuance and/or arbitration of bond instruments: (1) to deter persons from making unauthorized disclosures of confidential information or committing other misconduct with respect to confidential information, and (2) to compensate persons whose confidential information has been the subject of such misconduct. The bond instrument is broadly referred to herein as a Non-Disclosure Bond (or “NDB”).

### BRIEF DESCRIPTION OF THE DRAWINGS

The accompanying drawings, which are incorporated in and constitute a part of this specification, illustrate several embodiments of the invention and together with the description, serve to explain the principles of the invention.

FIG. 1 is a block diagram illustrating one embodiment of an NDB purchase transaction;

FIG. 2 is a block diagram illustrating one embodiment of an NDB transaction following a breach by the Receiving Party;

FIG. 3 is a block diagram illustrating one embodiment of an NDB transaction following compliance by the Receiving Party.

### DETAILED DESCRIPTION OF THE EMBODIMENTS

In the following description, for the purposes of explanation, numerous specific details are set forth to provide a thorough understanding of the present invention. As will be evident to one skilled in the art, however, the exemplary embodiments may be practiced without these specific details. In other instances, structures and device are shown in diagram form in order to facilitate description of the exemplary embodiments.

Reference will now be made in detail to embodiments of the present invention, examples of which are illustrated in the accompanying drawings. Wherever possible, the same reference numbers will be used throughout the drawings to refer to the same or like parts. Although the following embodiments are described with reference to specific examples, the skilled artisan will recognize that no single element of the described embodiments is necessary for the successful practice of the invention, and that the invention can be practiced in various other combinations beyond those described.

In one embodiment, an NDB is created and arranged to establish a substantial financial disincentive against disclosure by the recipient of confidential information. In another embodiment, an NDB can be structured to indemnify or partially indemnify Disclosing Parties against financial loss as the result of misuse of confidential information.

Preferably, the NDB provides a source of funds that is quickly and easily distributed to the Disclosing Party in the event of a breach by a Receiving Party. For example, the NDB preferably eliminates or reduces the risk that a breaching disclosing party does not have or is not willing to pay the damages that may result from disclosing confidential information in breach of a contract. Assuming the Disclosing Party succeeds in showing a contract breach, the NDB will provide a source of funding for damages. Thus the NDB provides more certainty that a Receiving Party in breach will in fact pay damages to the Disclosing Party. Advantageously, the NDB is capable of deterring unauthorized disclosure more effectively than conventional contractual indemnification and liability policies. Deterring the disclosure of confidential information may prevent valuable information from being improperly disclosed and prevent disputes from arising in the first place.

The NDB protects trade secret value in several ways. In some embodiments, losses resulting from the disclosure of a trade secret can be followed by payment of either a fixed value of a security deposit or an agreed or appraised value of the trade secret. Additionally, by creating a financial instrument which explicitly or implicitly places a penalty on the disclosure of confidential information, some embodiments of an NDB may help trade secret owners defend against claims that their confidential information was not properly guarded as a trade secret.

In some embodiments, the NDB may help owners of patents and trademarks defend against a claim of laches or estoppel. In some cases, preservation of intellectual property rights requires certain actions by the owner. If an owner does not take steps to protect intellectual property rights, those rights may be compromised or lost. In some embodiments, an NDB provides protection of intellectual property that may reduce the risk of losing intellectual property rights due to laches or estoppel.

In some embodiments, an NDB can save money by substituting for liability insurance policies. Typically a surety bond premium is less than an insurance premium. Furthermore, in some embodiments of the invention, the deductible that is commonly required for insurance policies is not required for payment of the NDB.

The NDB can provide many advantages to parties engaged in transactions involving confidential information. In some embodiments, an NDB may reduce uncertainty and save money by limiting resolution of the dispute to a relatively fixed scope (for example, a two-day arbitration hearing). In some embodiments, an NDB may reduce uncertainty and save money by limiting resolution of the dispute to a relatively narrow question (for example, was the confidential information disclosed without authorization?) rather than needing to prove intent or loss. In some embodiments, an NDB can reduce reliance on the reputation and good faith behavior of the Receiving Party and of the Receiving Party's insurer. The NDB can also be used to signal the quality and ethical standards of service providers and other entities that seek to receive or otherwise be entrusted with confidential information (for example, trade secrets and other intellectual property).

An alternative embodiment provides an indemnification bond, which supports valuation of IP and other intangibles, offers underwriting techniques and standards broadly similar to standard fidelity risk management, facilitates the development of claims/underwriting databases, enhances loss control techniques, offers focused, well-defined coverage, and requires rigorous proofs of loss, replacing vague & broad contractual indemnities. This embodiment also eliminates counter-party credit risk, offers efficiencies and synergies with professional Errors & Omissions coverage, and sets price limits with respect to short-term financial risk or dislocation caused by impairment of an intangible asset. Embodiments of an indemnification bond can also confer price transparency to know-how, which is an intangible asset.

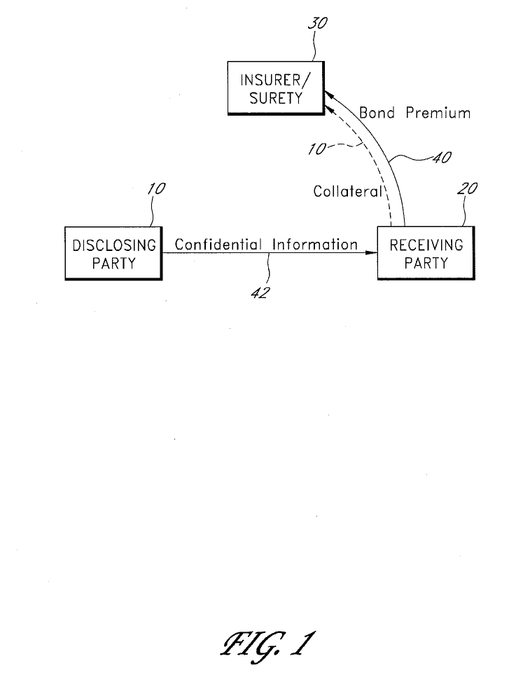

FIG. 1 illustrates one embodiment of an NDB purchase transaction between parties to an agreement relating to specified confidential information 42. The agreement relating to confidential information 42 can take any form as long as it includes an obligation not to disclose confidential information 42. In some embodiments, the agreement is a non-disclosure agreement (“NDA”). As used herein, confidential information 42 should be given its broadest meaning in view of the present disclosure. Confidential information 42 can be the content of any confidential disclosure and may include but is not limited to, whether disclosed orally, in written form or otherwise: trade secrets, proprietary information, know how, inventions, ideas, concepts, designs, materials, mask works, methods or processes, all works of authorship and copyrightable subject matter, any other intellectual property, improvements, modifications, developments, or derivative works relating to any intellectual property, all information designated as confidential, business data, operations data, manufacturing data, customer data/lists, marketing data, research and development data, or the like.

In some embodiments, prior to disclosing any confidential information 42, the Receiving Party 20 purchases an NDB from an Insurer 30. Typically, by purchasing the NDB the Receiving Party 20 enters into an agreement with the Insurer 30 defined by the terms of the NDB. Preferably, the Disclosing Party 10 is named as a beneficiary to the NDB. Preferably, once the NDB has been purchased, the Disclosing Party 10 will share the specified confidential information 42 with the Receiving Party 20. The Receiving Party's 20 obligation to purchase the NDB can be imposed by any legally binding agreement. In some embodiments, the obligation to purchase the NDB is included in an NDA or other agreement between the Disclosing Party 10 and the Receiving Party 20. It is also contemplated that there is no formal obligation to purchase the NDB. In such embodiments, the confidential information 42 would not be disclosed until after an NDB is purchased that identifies the Disclosing Party 10 as a beneficiary.

In an alternative embodiment, the invention includes an NDA that protects and obligates parties beyond the parties that directly disclose and/or directly receive the confidential information 42. For example, there may be third parties that will receive the confidential information 42, and disclosure of the confidential information 42 by these third parties may result in pay out of the NDB. Preferably, the NDA or other agreement specifies third parties that are authorized to receive the confidential information 42 and expands the trigger for the NDA pay out to disclosure of confidential information 42 by third parties in breach of the agreement. The third parties may include but are not limited to a Receiving Party's 20 sublicensees, manufacturers, distributors, or any other individual and/or entity that may have authorized access to the confidential information 42. It is also contemplated that parties other than the Disclosing Party 10 may be beneficiaries to the NDB. For example, the Disclosing Party 10 may not be the original source of the confidential information 42, but may be an intermediary between an original source and the Receiving Party 20. In some embodiments, breach of an NDA between the Disclosing Party 10 and the Receiving Party 20 may trigger an NDB pay out to the original source of the confidential information 42. There may be several relationships and parties that are related to the disclosure of confidential information 42, and the invention is not limited to any specific relationship or party.

The holder of the NDB (i.e., the Insurer 30 in the embodiment of FIG. 1) may be a third-party insurer (either a traditional insurer or a captive), or in some embodiments a different type of entity. In some embodiments, the Insurer may consist of a financial institution such as an investment bank, a merchant bank, or a commercial bank. In some embodiments, the Insurer 30 may be made up of a combination of entities which may be contractually bound to one another, such as an underwriter and a financial institution. In some embodiments, the Insurer 30 may be a captive insurance entity as described, for example, in co-pending patent application Ser. No. 11/401,095, filed on Apr. 10, 2006, which is hereby incorporated herein by reference. Alternatively or conjunctively, the Disclosing Party 10 may utilize structured self-insurance to obtain tax and reserving advantages in connection with existing fortuitous risks.

In one embodiment, the total value of the NDB is preferably selected to be sufficiently large as to deter the Receiving Party 20 from disclosing the confidential information 42. Such an amount will often be highly dependent on characteristics of the Receiving Party 20, such as the size, legal entity status, gross and/or net revenue, net assets, current assets, market capitalization, debt covenants, prior year sales, prior year net income, book value, longevity, and other factors. For example, the total value of the NDB may be selected to be a substantial percentage of the total book value of a Receiving Party's 20 assets. In one embodiment, the total disclosure bond value may be selected to be equal to about 10% to about 50% of the total book value of a Receiving Party's 20 assets, but it could be any percentage of a Receiving Party's assets. In an alternative embodiment, the NDB value may be selected to be greater than the appraised value of a selected quantity of a Receiving Party's 20 assets. In some embodiments, the total bond value may be at least partially based on the reputation, business practices, solvency, ethics and conscientiousness of the Receiving Party 20.

Alternatively, or in addition, the total value of the NDB may be at least partially based on factors external to the Receiving Party 20, such as the value of the confidential information 42. In some embodiments, the value of the NDB may be dependent on the technical area of the assets. For example, the total value of the NDB may be a minimum fixed amount for a particular technical area (for example, $1,000,000). In other embodiments, the total value of the NDB may be another predetermined or fixed value selected by the Disclosing Party 10, or by the Receiving Party 20.

In one embodiment, the total NDB value may be proportional to an objectively measured quality rating of the confidential information 42. This is especially applicable when the confidential information 42 is an intellectual property asset. For example, an intellectual property asset may be rated according to a statistical rating algorithm such as that described in U.S. Pat. No. 6,556,992, titled METHOD AND SYSTEM FOR RATING PATENTS AND OTHER INTANGIBLE ASSETS which was filed on Sep. 14, 2000, the entire contents of which is hereby incorporated herein by reference. Such a rating system can be used to determine a numeric value representing a qualitative value of the asset. In some embodiments, the total NDB value may be determined with reference to such a qualitative value, such as by multiplying the qualitative value by a fixed currency amount. For example, in one embodiment, the total NDB value may be determined by multiplying the qualitative value by a currency denominated factor, such as $1,000, $10,000, $100,000, $1,000,000, etc.

In some embodiments, the total value of the NDB will be determined without conducting any valuation or appraisal of the confidential information 42 to be shared. According to some such embodiments, the total bond value is based entirely on factors designed to establish an amount that will be a sufficient deterrent to the Receiving Party 20, without necessarily being tied to any actual or appraised value of the assets.

In many embodiments, the total value of the NDB may be substantially less than an appraised value of the confidential information 42 being disclosed. In one embodiment, the terms of the disclosure bond allow any remaining value (for example, any appraised asset value in excess of the total bond value) of the disclosed confidential information 42 and any damage caused by the disclosure of such confidential information 42 to be recovered by the Disclosing Party 10 through a different type of dispute resolution process (for example, litigation, mediation, or arbitration).

In an alternative embodiment, the total value of the NDB is at least partially based on an appraised value of the confidential information 42 to be disclosed. In some embodiments the total NDB value may equal or exceed the appraised value of the confidential information 42 to be disclosed. For example, in some embodiments, the purpose of the NDB would be to substantially indemnify the Disclosing Party 10 for any loss associated with the Receiving Party's 20 disclosure of the confidential information 42.

Once a total NDB value is established, the Receiving Party 20 preferably provides the Insurer 30 with a Premium 40 which may be an amount up to the full value of the NDB. In various embodiments, the Premium 40 can be paid by transferring to the Insurer 30 any of a variety of assets, such as cash, stock, intellectual property, and so on. In some embodiments, the Receiving Party 20 will also provide the Insurer 30 with assets to be held as Collateral 50. The Collateral 50 may take any form, including tangible assets, intangible assets, or even cash. The transfer of Collateral 50 to the Insurer 30 may occur in the form of a lien, a physical transfer of assets, a legal transfer in the title to the assets, or any other type of transfer. In some embodiments, the Receiving Party 20 will pay the Insurer 30 only a Premium 40. In other embodiments, the Receiving Party 20 will pay the Insurer a combination of a Premium 40 and Collateral 50.

In some embodiments, the Premium 40 may be paid in a single, lump sum. Alternatively, the Premium 40 may be split up into a series of periodic payments with (or without) additional interest. The Premium 40 will typically be some percentage of the total NDB value. For example, in one embodiment, the Premium 40 may be up to about 5% of the total NDB value. In other embodiments, the NDB Premium 40 may be up to about 10% of the total NDB value. In still further embodiments, the NDB Premium 40 may be as much as 50% or more of the total NDB value. In one embodiment, the NDB Premium 40 may be determined on the basis of the credit, reputation, business practices, solvency, ethics, conscientiousness, and/or internal confidential information safeguards of the Receiving Party 20, and may also be determined based on the amount of Collateral 50, if any, put up by the Receiving Party 20.

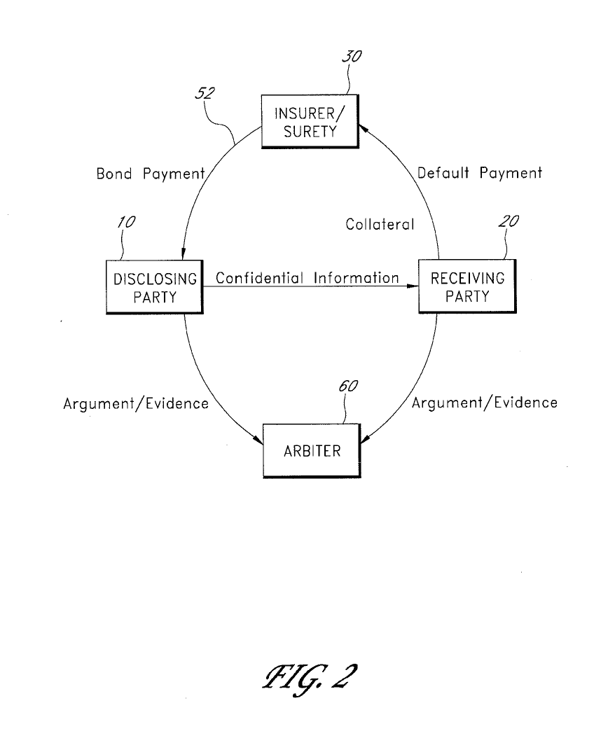

FIG. 2 illustrates a transaction resulting from a breach of the NDA or NDB by the Receiving Party 20. The specific factors comprising a breach will typically be defined by the NDA or NDB itself, but for the purposes of this discussion will generally be defined as any unauthorized disclosure or other misuse of confidential information 42.

According to one embodiment of the invention, if the Disclosing Party 10 comes to suspect the Receiving Party 20 of having breached the terms of the NDA or NDB, the parties will bring their dispute to a dispute resolution process. The dispute resolution process can take any form and is preferably predefined in an agreement (for example, the NDA or NDB) between the Disclosing Party 10 and the Receiving Party 20.

The procedural aspects of the dispute resolution process can take any form. Preferably, the procedural aspects of the dispute resolution process are agreed upon between the Disclosing Party 10 and the Receiving Party 20 in an agreement. In some embodiments, the agreement may specify a dispute resolution process before a body that has pre-defined procedural requirements. In some embodiments, the parties bring the dispute before a neutral third-party Arbiter 60. Typically, arbitration is a less expensive alternative to litigation. Preferably this removes barriers to enforcement of confidentiality provisions that may exist when parties are faced with the prospect of expensive litigation. The length of the arbitration procedure will, in one embodiment, be limited in time (for example, 3 days) and/or in scope of inquiry (for example, was the confidential information disclosed without authorization?). In alternative embodiments, the arbitration proceedings may be limited to longer periods of time, such as seven to ten days, or the arbitration proceedings may be open-ended with no fixed duration.

During the arbitration proceedings, the Disclosing Party 10 will preferably be required to prove certain factual matters. For example, the Disclosing Party 10 may be required to show evidence that identifies the confidential information 42 at issue. The Disclosing Party 10 may also be required to support the classification of the confidential information 42 (for example, patent, trademark, copyright, etc.). The Disclosing Party 10, in most, but not all embodiments, will not be required to prove the validity of the property right.

In some embodiments, the Disclosing Party 10 would have the burden of proving the act, error, omission or other misconduct by the Receiving Party 20. The level proof that the Disclosing Party must show can be any level that the parties agree upon (for example, more probable than not that a disclosure took place that was in breach of the agreement). In some embodiments, the level of proof required is decided by the arbiter. However, in most, but not all, embodiments, the Disclosing Party 20 would not be required to prove that the misconduct damaged, impaired or otherwise caused harm or loss to the Disclosing Party 20. In some embodiments, the Disclosing Party 10 may be required to establish the extent and amount of loss covered by the NDB, and may claim payment only in that amount (and only up to the full value of the NDB).

In some embodiments, in the event that the Receiving Party 20 can be shown to have breached the terms of the NDA or NDB, all or an agreed portion of the value of the NDB (the “Bond Payment” 52) will be paid to the Disclosing Party 20. In most, but not all, embodiments, the Insurer 30 will retain the Premium 40 irrespective of any Bond Payment 52 made to the Disclosing Party 10 or any amount returned to the Receiving Party 20.

In some embodiments, an Insurer 30 that pays any portion of the NDB value to the Disclosing Party 10 may seek recovery from the Receiving Party 20 of the amount paid to the Disclosing Party 10. In some embodiments, this recovery may be had by retaining Collateral 50 held, or by exercising a lien against tangible or intangible assets of the Receiving Party 20, or by bringing an action against the Receiving Party 20. In most, but not all, embodiments, such an action would be governed by the same or similar dispute resolution procedures (for example, arbitration) as are set forth above with respect to disputes between Disclosing Parties 10 and Receiving Parties 20.

In some embodiments, the NDB may be written in such a way as to attach in excess of existing Errors & Omissions (E&O), malpractice, or other similar policy, if any, with respect to inadvertent or negligent disclosures, and to apply on a primary basis in the case of willful or reckless disclosures normally excluded in an E&O, malpractice, or other similar policy.

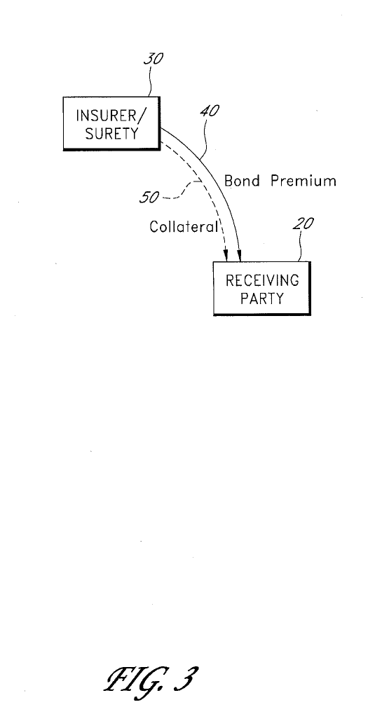

In embodiments where Collateral 50 is put up by the Receiving Party 20, the Collateral 50 will typically be refunded to the Receiving Party 20 following an agreed upon period of compliance (for example, expiration of the terms of an NDA). See FIG. 3. The Insurer 30 will typically retain all or a portion of the Premium 40. In some embodiments, a portion of the Premium 40 is returned to the Receiving Party 20 following an agreed upon period of compliance.

In an alternative embodiment, a similar bond may be used to deter breaches and/or compensate for breaches of contract terms other than confidentiality provisions. For example, a bond similar to the NDB described above could be employed to prevent parties from engaging in conduct that violates various types of terms in a license agreement. For example, the bond could be used to deter and/or compensate for use of technology beyond the rights granted in the license agreement or for failure to pay royalties or meet other obligations of the license agreement. In some embodiments, the pay out of the bond may be available in varying levels, depending on the type of provision that is breached. Preferably, the level of pay out for each type of breach is predefined by the parties.

In some embodiments, the acts described herein are implemented within, or using, software modules (programs) that are executed by one or more general purpose computers. The software modules may be stored on or within any suitable computer-readable medium. It should be understood that the various steps may alternatively be implemented in-whole or in-part within specially designed hardware. The skilled artisan will recognize that not all calculations, analyses and/or optimization require the use of computers, though any of the above-described methods, calculations or analyses can be facilitated through the use of computers.

Although this invention has been disclosed in the context of certain preferred embodiments and examples, it will be understood by those skilled in the art that the present invention extends beyond the specifically disclosed embodiments to other alternative H embodiments and/or uses of the invention and obvious modifications and equivalents thereof. Additionally, the skilled artisan will recognize that any of the above-described methods can be carried out using any appropriate apparatus. Thus, it is intended that the scope of the present invention herein disclosed should not be limited by the particular disclosed embodiments described above.

What is claimed is:

1. A method of facilitating the sharing of confidential information between a disclosing party and a receiving party, the method comprising:
entering into a first agreement that obligates the receiving party in regard to the confidential information;
transferring a first asset to an insurer as a premium for a non-disclosure bond; and
entering into a second agreement that the non-disclosure bond may be forfeited in the event that the receiving party discloses the confidential information in breach of the first contract.

2. The method of claim 1, further comprising transferring a second asset to the insurer as collateral for the non-disclosure bond.

3. The method of claim 2, further comprising receiving the second asset from the insurer following a period of compliance.

4. The method of claim 1, wherein the premium is based on a total value of assets owned by the receiving party.

5. The method of claim 1, wherein the premium is based on an estimated value of the confidential information.

6. The method of claim 1, wherein the first agreement and the second agreement are contained in a first contract.

7. The method of claim 1, wherein the first agreement specifies a requirement to purchase the non-disclosure bond.

8. A method of deterring a receiving party from breaching a confidentiality term in an agreement with a disclosing party, the method comprising:
receiving a premium for a non-disclosure bond, the non-disclosure bond specifying a first value to be paid to the disclosing party if the receiving party is determined to have breached the confidentiality term.

9. The method of claim 8, further comprising transferring a first asset of the first value to the disclosing party in response to a determination that the receiving party has breached the confidentiality term.

10. The method of claim 9, wherein the determination that the receiving party has breached the confidentiality term is made in an arbitration process.

11. The method of claim 9, wherein the determination that the receiving party has breached the confidentiality term is made in a court of law.

12. The method of claim 8, further comprising receiving a security interest in a second asset as collateral for the non-disclosure bond.

13. The method of claim 12, further comprising releasing the security interest in the second asset after a period of compliance.

14. The method of claim 8, further comprising returning at least a portion of the premium after a period of compliance.

15. A method of arbitrating a dispute between a receiving party and a disclosing party, wherein the receiving party has entered into a first agreement not to disclose certain confidential information and wherein the receiving party has paid a premium to purchase a non-disclosure bond from an insurer, the method comprising:
determining if the receiving party has disclosed the confidential information in breach of the first agreement; and
communicating to the insurer a finding that the receiving party has disclosed the confidential information in breach of the first agreement, wherein said finding will cause the insurer to make payment to the disclosing party according to terms of the non-disclosure bond.
